(19) United States
(12) Patent Application Publication
(10) Pub. No.: US 2010/0013961 A1
(43) Pub. Date: Jan. 21, 2010

(54) Pixel sensor array and image sensor for reducing resolution degradation

(75) Inventor: Kyoung Tai Lee, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/314,619

(22) Filed: Dec. 12, 2008

(30) Foreign Application Priority Data
Jul. 18, 2008 (KR) 10-2008-0070175

(51) Int. Cl. H04N 5/217; G06K 9/32

(52) U.S. Cl. 348/241; 382/299

(57) ABSTRACT

There are provided a pixel sensor array and an image sensor including the pixel sensor. The pixel sensor array includes: a first sensor pixel group disposed in a predetermined central portion and including a plurality of pixel sensors sensing incident light; and a second pixel sensor group disposed in a peripheral portion around the central portion and including a plurality of pixel sensors sensing the incident light, the peripheral portion includes a greater number of pixels per unit area than the central portion.

### CROSS-REFERENCE TO RELATED APPLICATIONS

This application claims the priority of Korean Patent Application No. 2008-0070175 filed on Jul. 18, 2008, in the Korean Intellectual Property Office, the disclosure of which is incorporated herein by reference.

### BACKGROUND OF THE INVENTION

1. Field of the Invention

The present invention relates to a pixel sensor array and an image sensor for reducing resolution degradation applicable to a camera, and more particularly, to a pixel sensor array and an image sensor in which a relatively greater number of pixels per unit are arranged in a peripheral portion than a central portion, thereby increasing resolution of the peripheral portion over the central portion to ensure less resolution degradation.

2. Description of the Related Art

In general, as a visual communication technology using a wire and wireless super-highway telecommunication network and a visual input and recognition technology such as a digital camera are advanced and accordingly a digital camera module is increasingly employed in a mobile phone or a vehicle, an image sensor applied to the digital camera module has been vigorously researched and developed.

This image sensor senses light reflected by an object to sense an image of the object. The image sensor breaks down into a charge coupled device (CCD) type and a complementary metal oxide semiconductor (CMOS) type according to a manufacturing process technique thereof.

The CCD image sensor transfers electrons generated by light to an output part using a gate pulse. Accordingly, the number of electrons remains unchanged even though a voltage is altered by external noise during the transfer. This prevents the noises from influencing an output signal, thereby ensuring excellent noise characteristics. Owing to this advantage, the CCD image sensor is utilized considerably in a multimedia device such as a digital camera and a camcorder, which requires high image quality.

On the other hand, the CMOS image sensor converts electrons generated by light into a voltage in each pixel and outputs the voltage through several CMOS switches. At this time, a voltage signal is altered by noise, thus leading to poor noise characteristics. However, advantageously, the CMOS image sensor, i.e., CIS is manufacturable at a lower cost, consumes less power and can be integrated with peripheral circuits. Therefore, in late 1990ies, the CMOS process technology has been developed and a signal processing algorithm has been improved to overcome existing drawbacks. Recently, the CMOS process has been more actively studied.

A conventional image processing device includes an image sensor including a micro lens, a color filter array, a protective layer and a pixel sensor array and a signal processing unit performing signal processing such as interpolation for color (R,G,B) signals from the image sensor.

FIG. 1 illustrates an arrangement of pixels of a conventional pixel sensor array.

The conventional pixel sensor array 10 shown in FIG. 1 includes a plurality of pixel sensors 11 arranged in a lattice configuration and each of the pixels has a predetermined size.

Meanwhile, as for a vehicle camera or a wide angle camera, with a gradual increase in an angle of view of a lens, a senor in a central portion of the pixel sensor array covers an area and distance different from a sensor in a peripheral portion of the pixel sensor array.

That is, the sensor in the peripheral portion of the pixel senor array covers an area larger than the sensor in the central portion of the pixel sensor array. Also, a distance between the sensor in the peripheral portion and an object is greater than a distance between the sensor in the central portion and the object. Accordingly, this leads to distortion in which an image obtained through the sensor in the central portion of the pixel sensor array is different in definition from an image obtained through the sensor in the peripheral portion. Particularly, the peripheral area is degraded in resolution as shown in FIG. 2.

This distortion is corrected by software, however disadvantageously accompanied by deteriorated resolution. This lower resolution considerably degrades quality of the image of the peripheral portion than the image of the central portion.

### SUMMARY OF THE INVENTION

An aspect of the present invention provides a pixel sensor array and an image sensor in which a relatively greater number of pixels per unit are arranged in a peripheral portion than a central portion, thereby increasing resolution of the peripheral portion over the central portion to reduce resolution degradation.

According to an aspect of the present invention, there is provided a pixel sensor array including: a first sensor pixel group disposed in a predetermined central portion and including a plurality of pixel sensors sensing incident light; and a second pixel sensor group disposed in a peripheral portion around the central portion and including a plurality of pixel sensors sensing the incident light, wherein the peripheral portion includes a greater number of pixels per unit area than the central portion.

Each of the pixel sensors of the second pixel sensor group may have a size smaller than each of the pixel sensors of the first pixel sensor group.

The central portion may include a central point of the pixel sensor array and covers a predetermined distance from the central point.

A proportion of the central portion in an entire area of the pixel sensor array is determined by a size of a predetermined angle of view.

The peripheral portion may include: a first peripheral portion adjacent to the central portion; and a second peripheral portion located around the first peripheral portion, wherein the second peripheral portion includes a greater number of pixels per unit area than the first peripheral portion.

Each of pixel sensors of the second peripheral portion may be smaller than each of pixel sensors of the first peripheral portion.

According to another aspect of the present invention, there is provided an image sensor including: a lens array including a plurality of micro lenses arranged in a plane lattice configuration; and a pixel sensor array including: a first sensor pixel group disposed in a predetermined central portion and including a plurality of pixel sensors sensing incident light; and a second pixel sensor group disposed in a peripheral portion around the central portion and including a plurality of pixel sensors sensing the incident light, wherein the peripheral portion includes a greater number of pixels per unit area than the central portion.

Each of the pixel sensors of the second pixel sensor group may have a size smaller than each of the pixel sensors of the first pixel sensor group.

The central portion may include a central point of the pixel sensor array and covers a predetermined distance from the central point.

A proportion of the central portion in an entire area of the pixel sensor array may be determined by a size of a predetermined angle of view.

The peripheral portion may include: a first peripheral portion adjacent to the central portion; and a second peripheral portion disposed around the first peripheral portion, wherein the second peripheral portion includes a greater number of pixels per unit area than the first peripheral portion.

Each of pixel sensors of the second peripheral portion may be smaller than each of pixel sensors of the first peripheral portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates an arrangement of pixels of a conventional pixel sensor array;

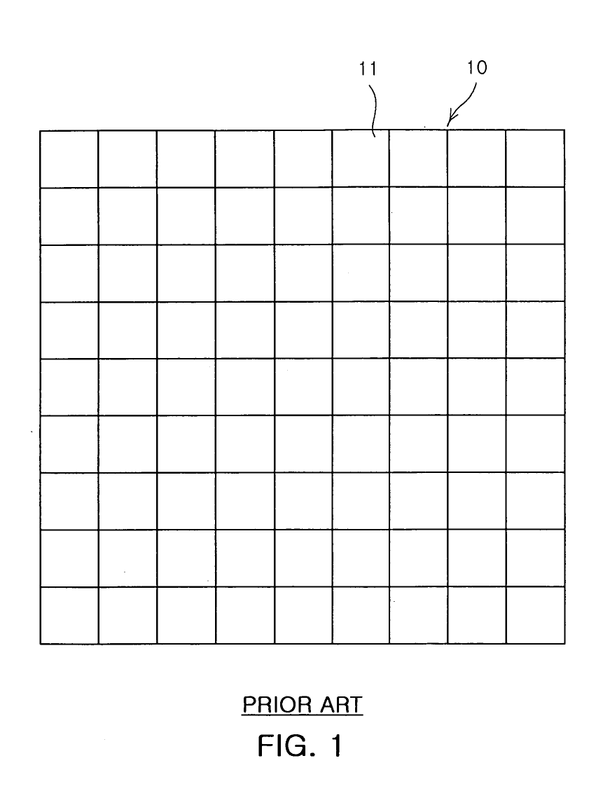

FIG. 2 illustrates an image taken using a conventional pixel sensor array;

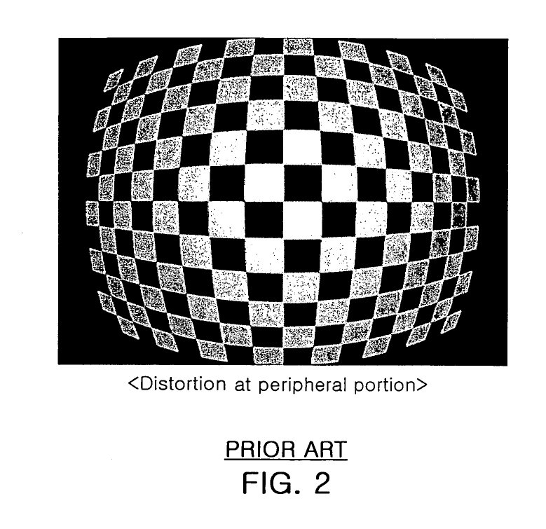

FIG. 3 illustrates an arrangement of pixels of a pixel sensor array according to an exemplary embodiment of the invention;

FIG. 4 illustrates in detail an arrangement of pixels of a pixel sensor array according to an exemplary embodiment of the invention;

FIG. 5 illustrates a structure of an image sensor according to an exemplary embodiment of the invention; and

FIG. 6 illustrates an image taken using a pixel sensor array according to an exemplary embodiment of the invention.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference signs are used to designate the same or similar components throughout.

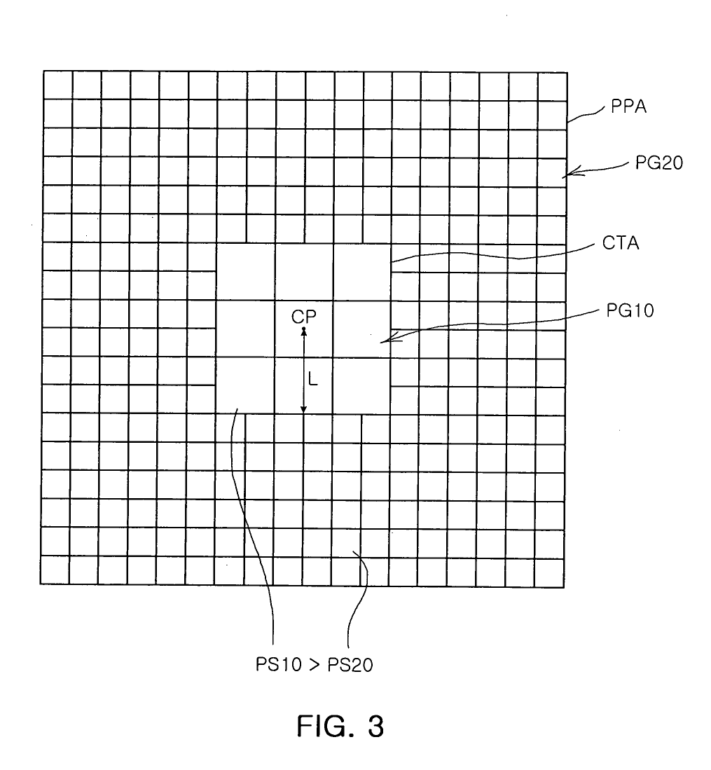

FIG. 3 illustrates an arrangement of pixels of a pixel sensor array according to an exemplary embodiment of the invention.

Referring to FIG. 3, the pixel sensor array of the present embodiment includes a first pixel sensor group PG10 and a second pixel sensor group PG20. The first pixel sensor group PG10 is disposed in a predetermined central portion CTA and includes a plurality of pixel sensors sensing incident light. The second pixel sensor group PG20 is disposed in a peripheral portion PPA around the central portion CTA and includes a plurality of pixel sensors sensing the incident light.

The peripheral portion PPA includes a greater number of pixels per unit area than the central portion CTA.

For example, as shown in FIG. 3, the plurality of pixel sensors belonging to the central portion CTA are arranged in a mosaic pattern, and composed of one central pixel and eight neighboring pixels disposed therearound.

Each of the pixel sensors of the second pixel sensor group PG20 is smaller than each of the pixel sensors of the first pixel senor group PG10.

Accordingly, due to a smaller size of the pixel sensors in the second pixel sensor group PG20 than the pixel sensors in the first pixel sensor group PG10, the number of the pixel sensors of the second pixel sensor group PG20 per unit area is greater than the number of the pixel sensors of the first pixel sensor group PG10 per unit area.

Therefore, the pixel sensor array of the present invention ensures relatively better resolution at the peripheral portion than the central portion, thus enhancing image quality at the peripheral portion over the central portion. This eliminates a problem associated with a conventional pixel sensor array and accordingly improves quality of an image taken.

The central portion CTA includes a central point of the pixel sensor array and may cover a predetermined distance L from the central point CP.

For example, referring to FIG. 3, the distance L may correspond to a distance from the central point CT of the pixel sensors of the central portion CTA to a boundary between the central portion CTA and the peripheral portion PPA.

Out of an entire area of the pixel sensor array, the central portion CTA has a proportion determined according to a predetermined angle of view.

For example, in the camera module employing the pixel sensor array of the present invention, an area ratio between the central portion and the peripheral portion is determined by an angle of view. That is, when the angle of view is 130 degrees, the area ratio between the central portion and the peripheral portion may be 60:40. Also, when the angle of view is 150 degrees, the area ratio between the central portion and peripheral portion may be 50:50. Furthermore, when the angle of view is 180 degrees, the area ratio between the central portion and peripheral portion may be 40:60.

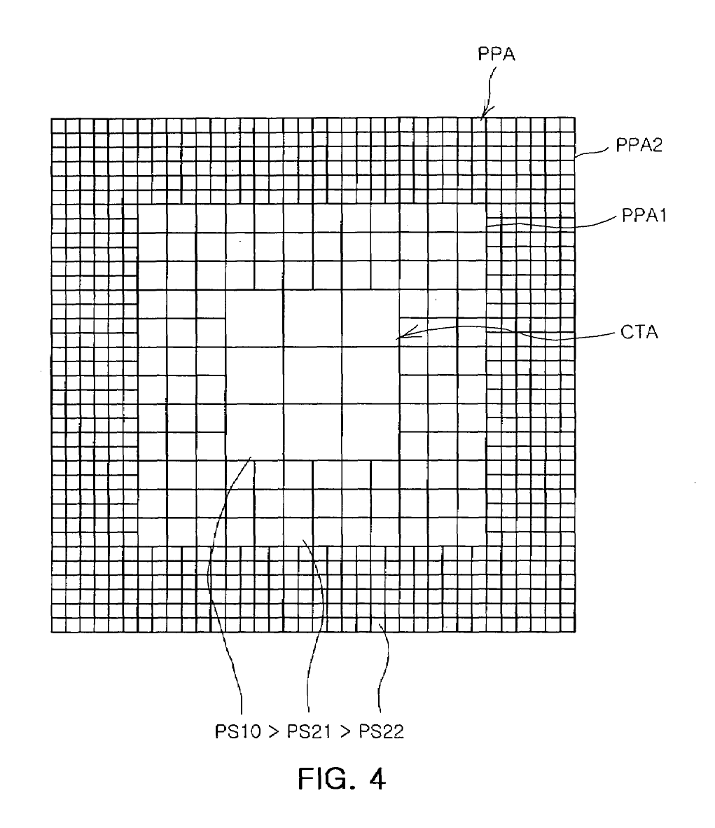

FIG. 4 is a detailed view illustrating an arrangement of a pixel sensor array according to an exemplary embodiment of the invention.

Referring to FIG. 4, in the pixel sensor array, a peripheral portion PPA located in the vicinity of the central portion CTA can be divided into smaller portions to enhance resolution.

For example, the peripheral portion PPA includes a predetermined first peripheral portion PPA1 adjacent to the central portion CTA and a second peripheral portion PPA2 located in the vicinity of the first peripheral portion PPA1. The second peripheral portion PPA2 includes a greater number of pixels per unit area than the first peripheral portion PPA2.

Each of the pixel sensors of the second peripheral portion PPA2 is smaller than each of pixel sensors of the first peripheral portion PPA1.

Meanwhile, the image sensor of the present invention may employ the pixel sensor array described above. Here, the image sensor of the present invention may include a lens array including a plurality of micro lenses arranged in a plane lattice configuration and a pixel sensor array.

As described above, the pixel sensor array is disposed in a predetermined central portion CTA. The pixel sensor array includes a first pixel sensor group PG10 including a plurality of pixel sensors sensing incident light and a second pixel sensor group PG20 disposed in a peripheral portion PPA around the central portion CTA and including a plurality of pixel sensors sensing the incident light. The peripheral portion PPA has a greater number of pixels than the central portion CTA.

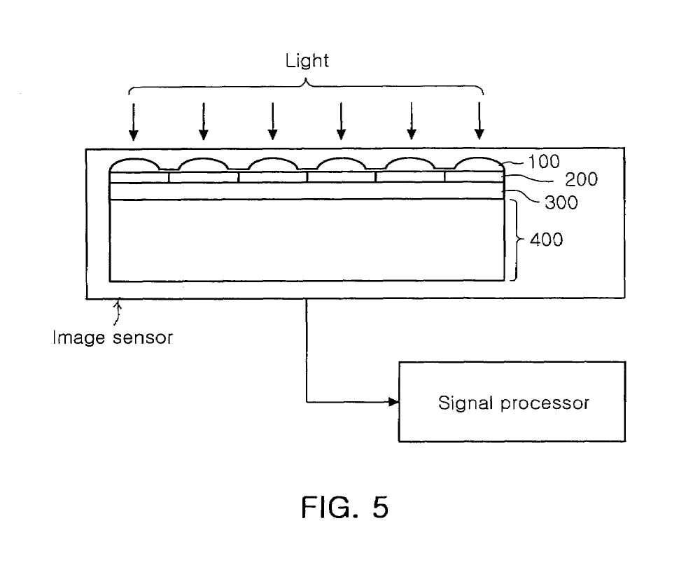

The image sensor of the present embodiment maybe formed of a color image sensor configured as shown in FIG. 5.

FIG. 5 illustrates a structure of an image sensor according to an exemplary embodiment of the invention.

Referring to FIG. 5, the image sensor of the present embodiment includes a lens array 100 including a plurality of micro lenses arranged in a plane lattice configuration, a color filter array 200 disposed below the lens array 100 and including a plurality of color filters, a protective layer 300 formed below the color filter array 200 and the pixel sensor array 400 described above.

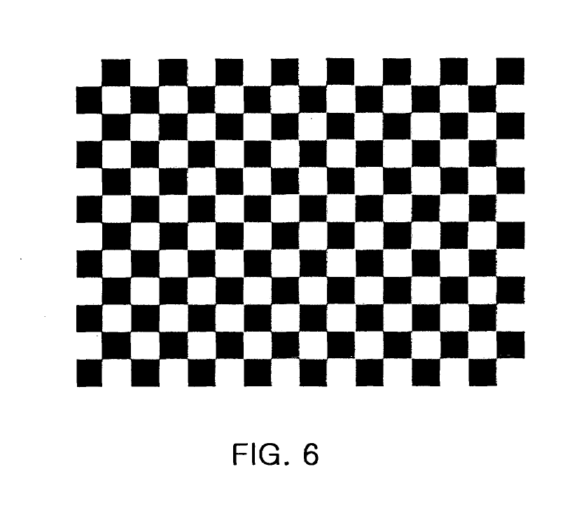

FIG. 6 is a view illustrating an image taken using the pixel sensor array of the present invention.

As shown in FIG. 6, the image taken using the pixel sensor array of the present embodiment ensures a greater number of pixels at a peripheral portion than a central portion, thereby ensuring less image degradation at the peripheral portion.

As described above, in the pixel sensor array of the present embodiment, the peripheral portion has a greater number of pixel sensors than the central portion, thus reducing image degradation which may occur at the peripheral portion.

As set forth above, according to exemplary embodiments of the invention, a peripheral portion disposed around a central portion has a relatively greater number of pixels than the central portion. This improves resolution at the peripheral portion over the central portion to ensure less resolution degradation.

While the present invention has been shown and described in connection with the exemplary embodiments, it will be apparent to those skilled in the art that modifications and variations can be made without departing from the spirit and scope of the invention as defined by the appended claims.

What is claimed is:

1. A pixel sensor array comprising:
a first sensor pixel group disposed in a predetermined central portion and including a plurality of pixel sensors sensing incident light; and
a second pixel sensor group disposed in a peripheral portion around the central portion and including a plurality of pixel sensors sensing the incident light,
wherein the peripheral portion includes a greater number of pixels per unit area than the central portion.

2. The pixel sensor array of claim 1, wherein each of the pixel sensors of the second pixel sensor group has a size smaller than each of the pixel sensors of the first pixel sensor group.

3. The pixel sensor array of claim 1, wherein the central portion includes a central point of the pixel sensor array and covers a predetermined distance from the central point.

4. The pixel sensor array of claim 3, wherein a proportion of the central portion in an entire area of the pixel sensor array is determined by a size of a predetermined angle of view.

5. The pixel sensor array of claim 1, wherein the peripheral portion comprises:
a first peripheral portion adjacent to the central portion; and
a second peripheral portion located around the first peripheral portion,
wherein the second peripheral portion includes a greater number of pixels per unit area than the first peripheral portion.

6. The pixel sensor array of claim 5, wherein each of pixel sensors of the second peripheral portion is smaller than each of pixel sensors of the first peripheral portion.

7. An image sensor comprising:
a lens array comprising a plurality of micro lenses arranged in a plane lattice configuration; and
a pixel sensor array including:
a first sensor pixel group disposed in a predetermined central portion and including a plurality of pixel sensors sensing incident light; and
a second pixel sensor group disposed in a peripheral portion around the central portion and including a plurality of pixel sensors sensing the incident light, wherein the peripheral portion includes a greater number of pixels per unit area than the central portion.

8. The image sensor of claim 7, wherein each of the pixel sensors of the second pixel sensor group has a size smaller than each of the pixel sensors of the first pixel sensor group.

9. The image sensor of claim 7, wherein the central portion includes a central point of the pixel sensor array and covers a predetermined distance from the central point.

10. The image sensor of claim 9, wherein a proportion of the central portion in an entire area of the pixel sensor array is determined by a size of a predetermined angle of view.

11. The image sensor of claim 7, wherein the peripheral portion comprises:
a first peripheral portion adjacent to the central portion; and
a second peripheral portion disposed around the first peripheral portion,
wherein the second peripheral portion includes a greater number of pixels per unit area than the first peripheral portion.

12. The image sensor of claim 11, wherein each of pixel sensors of the second peripheral portion is smaller than each of pixel sensors of the first peripheral portion.
